(19) United States
(12) Patent Application Publication
(10) Pub. No.: US 2017/0004296 A1
(43) Pub. Date: Jan. 5, 2017

(54) BIOMETRIC AUTHENTICATION METHOD AND BIOMETRIC AUTHENTICATION SYSTEM

(71) Applicant: PANASONIC INTELLECTUAL PROPERTY MANAGEMENT CO., LTD., Osaka-shi (JP)

(72) Inventor: KEIICHI TOIYAMA, Osaka (JP)

(21) Appl. No.: 15/114,071

(22) PCT Filed: Mar. 26, 2015
(86) PCT No.: PCT/JP2015/001720

§ 371 Date: Jul. 25, 2016

(30) Foreign Application Priority Data
Mar. 28, 2014 (JP) 2014-068193

(51) Int. Cl. G06F 21/32; H04W 12/06; G06F 21/62

(52) U.S. Cl. CPC G06F 21/32; G06F 21/6245; H04W 12/06; H04L 63/0861

(57) ABSTRACT

This A biometric authentication system includes manipulation equipment and terminal equipment configured to communicate with each other, wherein the manipulation equipment is configured such that biometric information of a user can be input thereto as first biometric information, the terminal equipment is configured such that the biometric information of the user can be registered beforehand as second biometric information, and the manipulation equipment is configured to transmit the first biometric information input by the user to the terminal equipment and request the terminal equipment to collate the first biometric information with the second biometric information.

### TECHNICAL FIELD

The present disclosure relates to a biometric authentication method and a biometric authentication system in which personal authentication is performed by means of biometric information.

### BACKGROUND ART

Personal authentication in which an individual is identified to determine whether or not the individual is a specific individual is performed in various scenes. The personal authentication is performed to determine whether or not a person is a specific individual who is permitted to conduct an operation, for example, when service on a network is provided to the specific individual using a computer, when payment by electronic settlement is performed, when a security door is opened to the specific individual, or the like. Moreover, a method of using an ID (IDentification) number, a password or the like for the personal authentication is generally performed.

Patent Literature 1 has disclosed a biometric authentication system that performs personal authentication, using biometric information. In this technique, use of the biometric information can make processing of the personal authentication simple and convenient, and can increase accuracy of the personal authentication. For the biometric information, for example a fingerprint, a voiceprint, a retina pattern, a vein pattern or the like is used. Hereinafter, performing the personal authentication using the biometric information is referred to as “biometric authentication”.

The biometric authentication system, for example, can make input of a password unnecessary in the personal authentication, thereby increasing convenience of an individual who performs the personal authentication (hereinafter, referred to as a “user”).

When the biometric authentication is performed in the biometric authentication system, collation between the biometric information registered in the system beforehand, and the biometric information of the user input using a biometric information input device or the like is performed.

For example, there is an ATM (Automatic Teller Machine) terminal that can perform the personal authentication, using a vein pattern of a palm, a finger or the like. In this ATM terminal, one piece of vein pattern data (vein pattern data registered beforehand) associated beforehand with an ATM card inserted into the ATM terminal, and vein pattern data of an ATM terminal user are collated to perform the personal authentication. The ATM terminal user inputs the vein pattern data to the ATM terminal by putting his or her palm or finger over a vein pattern reading device provided in this ATM terminal.

In the above-described biometric authentication system, when the biometric information is retained in the terminal that performs the personal authentication, management regarding information leakage (security management) needs to be performed on a terminal basis.

While in this example of the ATM terminal, collation between one piece of registered data and one piece of input data is performed on a one-to-one basis, the biometric information may be used for collation between a plurality of pieces of registered data and one piece of input data (collation on a many-to-one basis). As the above-described biometric authentication system, for example, there is a system in which a security door and biometric authentication are combined. In this system, the pieces of biometric information (e.g., fingerprints) of a plurality of individuals who are permitted to pass the security door are registered beforehand, and a user performs the biometric authentication (fingerprint authentication) every time he or she passes the security door. In this biometric authentication system, the personal authentication of the user is performed by the collation between the registered plurality of pieces of biometric information and the input one piece of biometric information.

However, in the above-described biometric authentication system that performs the collation on the many-to-one basis, as a number of registrants of the biometric information becomes larger, a possibility becomes higher that false authentication occurs, in which the registered individual is determined to be non-registered, or the non-registered individual is determined to be registered.

Moreover, in the biometric authentication system configured such that the biometric information is registered in a device that performs the biometric authentication, as devices that perform the authentication information are increased in number, the management regarding the information leakage (security management) becomes more difficult. As compared with a password or the like, it is more difficult to change the biometric information registered once in the biometric authentication system. Thus, the security management is very important in the biometric authentication system.

### CITATION LIST

### Patent Literature

PTL 1: Unexamined Japanese Patent Publication No. H11-316818

### SUMMARY

The present disclosure provides a biometric authentication method and a biometric authentication system that can simplify management of biometric information.

A biometric authentication system in the present disclosure includes manipulation equipment and terminal equipment configured to be able to communicate with each other. The manipulation equipment is configured such that biometric information of a user can be input thereto as first biometric information. The terminal equipment is configured such that the biometric information of the user can be registered beforehand as second biometric information. The manipulation equipment is configured to transmit the first biometric information input by the user to the terminal equipment and request the terminal equipment to collate the first biometric information with the second biometric information.

A biometric authentication method in the present disclosure is a biometric authentication method in a biometric authentication system including manipulation equipment and terminal equipment configured to be able to communicate with each other. This biometric authentication method includes the steps of inputting biometric information of a user to the manipulation equipment as first biometric information, transmitting the first biometric information from the manipulation equipment to the terminal equipment, requesting collation between the first biometric information and second biometric information from the manipulation equipment to the terminal equipment, the second biometric information being registered beforehand in the terminal equipment, and answering a result of the collation from the terminal equipment to the manipulation equipment.

Manipulation equipment in the present disclosure is manipulation equipment used in biometric authentication, wherein the manipulation equipment is configured such that biometric information of a user can be input thereto as first biometric information. The manipulation equipment is configured to transmit the first biometric information input by the user to terminal equipment, and request the terminal equipment to collate the first biometric information with biometric information of the user registered beforehand as second biometric information in the terminal equipment.

### BRIEF DESCRIPTION OF DRAWINGS

FIG. 1 is a diagram schematically showing one configuration example of a biometric authentication system in a first exemplary embodiment.

FIG. 2 is a flowchart showing one operation example when biometric authentication is performed in the biometric authentication system in the first exemplary embodiment.

FIG. 3 is a diagram schematically showing one configuration example of a biometric authentication system in a second exemplary embodiment.

FIG. 4 is a flowchart showing one operation example of the biometric authentication system in the second exemplary embodiment.

FIG. 5 is a flowchart showing one operation example of a biometric authentication system in a third exemplary embodiment.

FIG. 6 is a diagram schematically showing one configuration example of a biometric authentication system in a fourth exemplary embodiment.

FIG. 7 is a flowchart showing one operation example of the biometric authentication system in the fourth exemplary embodiment.

FIG. 8 is a diagram schematically showing one configuration example of a biometric authentication system in a fifth exemplary embodiment.

FIG. 9 is a flowchart showing one operation example of the biometric authentication system in the fifth exemplary embodiment.

FIG. 10 is a diagram schematically showing one configuration example of a biometric authentication system in a sixth exemplary embodiment.

FIG. 11 is a flowchart showing one operation example of the biometric authentication system in the sixth exemplary embodiment.

### DESCRIPTION OF EMBODIMENTS

Hereinafter, referring to the drawings as needed, exemplary embodiments will be described in detail. However, more detailed description than necessary may be omitted. For example, detailed description of well-known items or overlapping description of substantially the same configurations may be omitted. This is to avoid unnecessary redundancy in the following description, and facilitate understanding of those in the art.

The accompanying drawings and the following description are provided for those in the art to sufficiently understand the present disclosure, and are not intended to limit the subject described in the claims.

### First Exemplary Embodiment

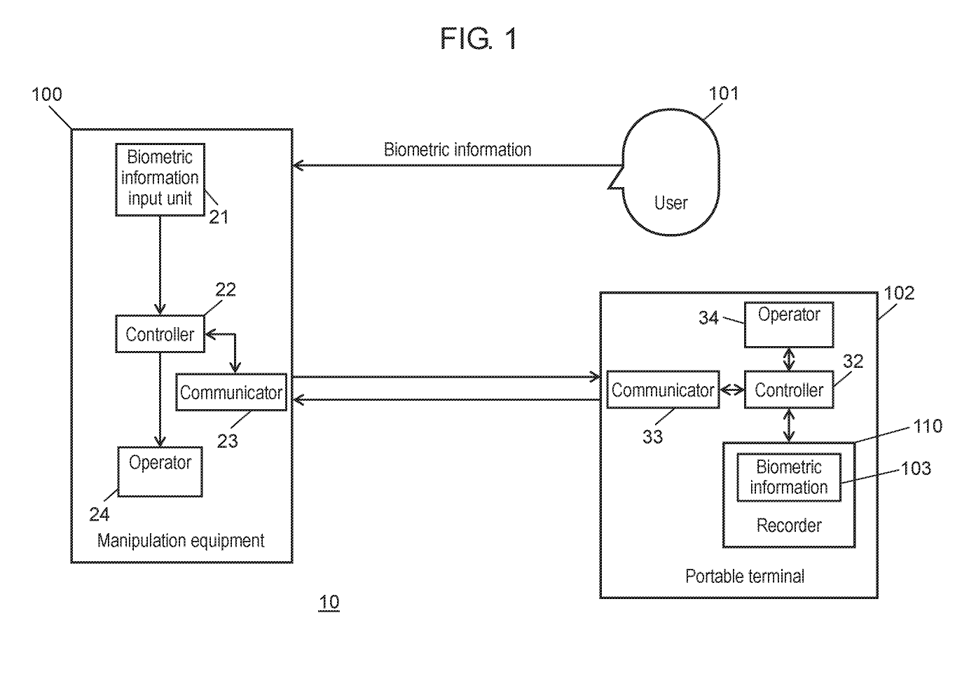

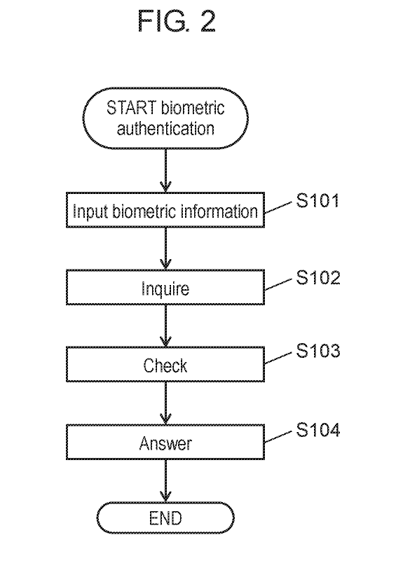

Hereinafter, referring to FIGS. 1 and 2, a first exemplary embodiment will be described.

### [1-1. Configuration]

FIG. 1 is a diagram schematically showing one configuration example of biometric authentication system 10 in the first exemplary embodiment.

As shown in FIG. 1, biometric authentication system 10 in the present exemplary embodiment includes manipulation equipment 100 and portable terminal 102 configured to be able to communicate with each other. Portable terminal 102 is one example of terminal equipment.

Manipulation equipment 100 includes biometric information input unit 21, controller 22, communicator 23, and operator 24. Manipulation equipment 100 is configured to perform personal authentication of user 101, based on biometric information (first biometric information) of user 101, and start subsequent operation if user 101 is determined to be a specific individual registered beforehand as a result of the personal authentication.

Portable terminal 102 includes controller 32, communicator 33, operator 34, and recorder 110. Portable terminal 102 is a terminal formed in size as capable of carrying the portable terminal 102 by user 101, and is, for example, a portable telephone or a smartphone. However, the present exemplary embodiment does not limit portable terminal 102 to these, but portable terminal 102 may be other equipment.

In manipulation equipment 100 and portable terminal 102 in FIG. 1, only components (blocks) relating to operation described in the present exemplary embodiment are shown, and others are omitted.

Manipulation equipment 100 and portable terminal 102 are configured to be able to communicate with each other by radio through communicator 23 and communicator 33. However, in the present exemplary embodiment, the communication method is not limited to the radio communication, but communicator 23 and communicator 33 may communicate with each other by wired communication using cable. Since the communication performed by communicator 23 and communicator 33 can be implemented, using a generally used communication technique, detailed description thereof is omitted.

Manipulation equipment 100 is, for example, configured to function as an electronic settlement terminal that accepts payment by electronic settlement. That is, operator 24 is a device configured to perform substantially the same operation as that of the generally used electronic settlement terminal. Operator 24 is configured to perform the operation, based on an instruction of permitting/not permitting of the operation output from controller 22. Manipulation equipment 100 is not limited to the electronic settlement terminal. Operator 24 of manipulation equipment 100 may be any device configured to perform the operation, based on the result of the personal authentication.

Biometric information input unit 21 is configured such that the biometric information of user 101 can be input thereto as the first biometric information. Biometric information input unit 21, for example, is configured to be able to read a fingerprint of user 101, create fingerprint information from the read fingerprint, and set the fingerprint information as the first biometric information. Since the reading of the fingerprint and the creation of the fingerprint information based on the read fingerprint can be implemented, using generally used techniques, detailed description is omitted. In the present exemplary embodiment, the biometric information input to biometric information input unit 21 is not limited to the fingerprint. The fingerprint is only one example of the biometric information, and anything that can be used as the biometric information may be input to biometric information input unit 21. As for the biometric information, for example, a voiceprint, a retina, an iris, a vein of a palm or a finger, a face or the like may be employed.

Controller 22 is configured to transmit the first biometric information output from biometric information input unit 21 to portable terminal 102 through communicator 23, and instruct permitting/not permitting of the operation to operator 24, based on a collation result returned from portable terminal 102. Controller 22 may control a display (not shown) to notify user 101 of success/failure of the personal authentication, based on the collation result.

In recorder 110 of portable terminal 102, biometric information 103 of user 101 is recorded beforehand as second biometric information. Recorder 110 is, for example, a semiconductor memory, and is configured such that writing/reading of data can be arbitrarily performed. Recorder 110 is not limited to the semiconductor memory, but may be configured by another storage device such as a hard disk, or the like.

Communicator 33 is configured to output, to controller 32, the first biometric information transmitted from manipulation equipment 100 upon receiving the first biometric information.

Controller 32 is configured to read out biometric information 103 recorded in recorder 110, collate biometric information 103 with the first biometric information upon receiving the first biometric information, and transmit the collation result to manipulation equipment 100 through communicator 33. This collation can be implemented, using a generally used method for collating both pieces of biometric information with each other, and thus, detailed description thereof is omitted.

Operator 34 is configured to execute general operation of portable terminal 102 (e.g., general operation as a portable telephone, general operation as a smartphone, or the like). The operation of operator 34 is substantially the same as the above-mentioned generally known operation, and thus, detailed description thereof is omitted.

Respective components (blocks) shown in FIG. 1 may be configured as electronic circuits, or may be configured to be implemented by executing a program in a processor.

While in FIG. 1, the configuration is shown in which one piece of manipulation equipment 100 and one portable terminal 102 communicate with each other, biometric authentication system 10 may include a plurality of portable terminals 102. That is, biometric authentication system 10 may be configured such that one piece of manipulation equipment 100 transmits the first biometric information to the plurality of portable terminals 102, and respective portable terminals 102 return the collation results to manipulation equipment 100.

### [1-2. Operation]

One operation example of biometric authentication system 10 configured as described above will be described below.

FIG. 2 is a flowchart showing the one operation example when the biometric authentication is performed in biometric authentication system 10 in the first exemplary embodiment.

User 101 inputs the biometric information (the first biometric information) to manipulation equipment 100 (step S101). While this biometric information is, for example, a fingerprint of user 101, other biometric information such as a vein, a voice, a retina, and the like may be employed. Manipulation equipment 100 inquires of portable terminal 102 whether or not the first biometric information acquired in step S101 and the second biometric information registered beforehand coincide with each other (step S102).

Specifically, manipulation equipment 100 transmits the first biometric information and data indicating a request for collation to portable terminal 102. In this manner, manipulation equipment 100 requests portable terminal 102 to collate the first biometric information with biometric information 103 recorded beforehand in portable terminal 102 (the second biometric information). A rule may be prescribed beforehand between manipulation equipment 100 and portable terminal 102 so that only transmission of the first biometric information allows the collation to be requested as well, which makes it unnecessary to transmit the data indicating the request for the collation from manipulation equipment 100 to portable terminal 102.

Portable terminal 102 collates the first biometric information with biometric information 103 to check whether or not the first biometric information coincides with biometric information 103 (step S103).

Specifically, upon receiving the first biometric information from manipulation equipment 100, portable terminal 102 reads out biometric information 103 from recorder 110. Biometric information 103 is the biometric information of user 101 registered beforehand (the second biometric information). Portable terminal 102 then collates the first biometric information with read biometric information 103. When biometric information 103 and the first biometric information coincides with each other, or when similarity between biometric information 103 and the first biometric information is higher than or equal to a predetermined threshold, portable terminal 102 determines that the first biometric information coincides with biometric information 103. Otherwise, portable terminal 102 determines that they are uncoincident. Since the collation of the biometric information in step S103 can be performed, using a generally used biometric information collation method, detailed description thereof is omitted.

Portable terminal 102 returns a result of the collation in step S103 to manipulation equipment 100 as a response to the inquiry from manipulation equipment 100 (step S104).

The response transmitted from portable terminal 102 to manipulation equipment 100 may be “YES” when both the pieces of the information are coincident, and “NO” when both pieces of the information are uncoincident. Moreover, information by which portable terminal 102 can be identified, such as, for example, an MAC address (Media Access Control Address), an IP address (Internet Protocol Address) of portable terminal 102 or the like, may be included in the response. This enables manipulation equipment 100 to smoothly start a next operation. Since manipulation equipment 100 can identify portable terminal 102 by receiving the IP address of portable terminal 102, manipulation equipment 100 can try to establish a communication path, for example, by WebSocket or the like to portable terminal 102 having the relevant IP address. When the communication path is established, an instruction can be transmitted from manipulation equipment 100 to portable terminal 102, for example, to cause portable terminal 102 to display an image to inquire whether or not to proceed with processing, or to cause portable terminal 102 to display an image to perform the next operation.

This configuration is effective in a case where communication needs to be performed between an electronic settlement terminal and portable terminal 102 to, for example, make a payment by electronic settlement in a store, or the like.

[1-3. Effects and the Like]

As described above, in the present exemplary embodiment, the biometric authentication system includes the manipulation equipment and the terminal equipment configured to be able to communicate with each other. The manipulation equipment is configured such that the biometric information of user 101 can be input thereto as the first biometric information. The terminal equipment is configured such that the biometric information of user 101 can be registered beforehand as the second biometric information. The manipulation equipment is further configured to transmit the first biometric information input by user 101 to the terminal equipment and request the terminal equipment to collate the first biometric information with the second biometric information.

In the present exemplary embodiment, biometric authentication system 10 is one example of the biometric authentication system, manipulation equipment 100 is one example of the manipulation equipment, portable terminal 102 is one example of the terminal equipment, and biometric information 103 is one example of the second biometric information.

In the biometric authentication system described in the present exemplary embodiment, the biometric authentication is performed, based on the biometric information stored in the portable terminal. There is a high possibility that the portable terminal is managed by the user himself or herself. This makes it unnecessary to store the highly confidential biometric information for which prevention of leakage is strongly desired, in the manipulation equipment, which has a high possibility of being used by a plurality of users. Accordingly, in the biometric authentication system described in the present exemplary embodiment, the management of the biometric information can be simplified, and security regarding information leakage can be increased.

Moreover, in the related art, for example, when the communication path is established between the electronic settlement terminal and the portable terminal, a telephone number, account information issued by an electronic settlement service provider, and the like need to be input to the electronic settlement terminal, and information on the electronic settlement terminal needs to be input to the portable terminal. However, in the present exemplary embodiment, the communication path can be established between portable terminal 102 and manipulation equipment 100, based on the result of the biometric authentication. Accordingly, various input manipulations, which are required in the related art, become unnecessary.

### Second Exemplary Embodiment

In a second exemplary embodiment, a biometric authentication system configured to be able to limit a portable terminal to which manipulation equipment is to request biometric authentication will be described.

There are cases where it is desirable to limit the portable terminal to which the manipulation equipment is to request the biometric authentication to the portable terminal near the manipulation equipment.

For example, at the time of payment using the electronic settlement terminal in a store, it is desirable that an object person of the settlement (an object terminal of the settlement) is limited to a user near the electronic settlement terminal (the portable terminal near the electronic settlement terminal), and that the portable terminal in a place away from the electronic settlement terminal such as the portable terminal or the like in an adjoining store is excluded from an object of the settlement.

In the above-described case, it is desirable that the portable terminal as a request destination of the biometric authentication is selected, or a permission of biometric authentication request acceptance is determined in the portable terminal, based on a distance between the manipulation equipment and the portable terminal. In this case, the biometric authentication system configured as described in the present exemplary embodiment is effective.

In the configuration described in the present exemplary embodiment, for example, information regarding a signal intensity of the portable terminal and quality of a received signal can be used, which information is obtained in a communication method in which a reachable distance of a communication radio wave is relatively short, such as, for example, NFC (Near Field Communication), BlueTooth (registered trademark), Wi-Fi (Wireless Fidelity), and the like.

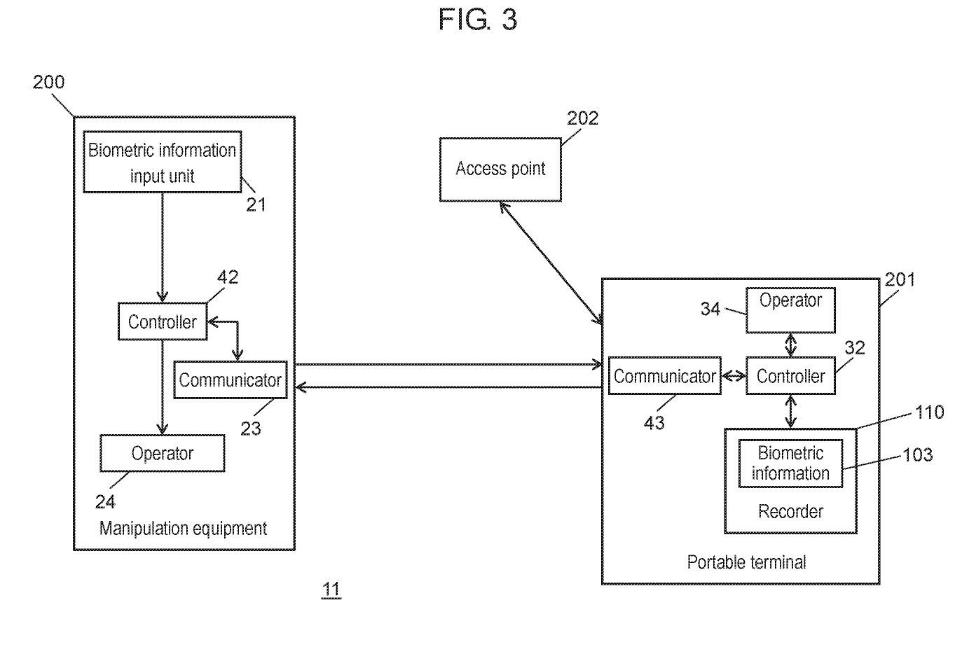

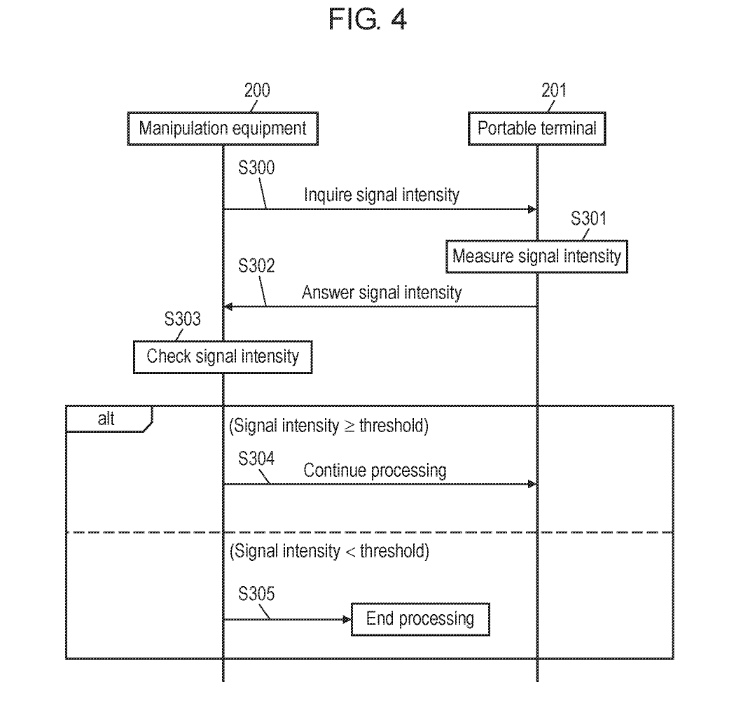

Hereinafter, the second exemplary embodiment will be described with reference to FIGS. 3 and 4.

In the present exemplary embodiment, an example in which the portable terminal uses Wi-Fi for radio communication will be described. However, communication means is not limited to Wi-Fi, but other communication means may be used.

### [2-1. Configuration]

FIG. 3 is a diagram schematically showing one configuration example of biometric authentication system 11 in the second exemplary embodiment.

As shown in FIG. 3, biometric authentication system 11 includes portable terminal 201 and manipulation equipment 200 configured to be able to communicate with each other. Portable terminal 201 is one example of terminal equipment.

Manipulation equipment 200 includes biometric information input unit 21, controller 42, communicator 23, and operator 24. Manipulation equipment 200 has substantially the same configuration and performs substantially the same operation as manipulation equipment 100 described in the first exemplary embodiment, and thus, detailed description thereof is omitted. Moreover, in a block diagram of manipulation equipment 200 shown in FIG. 3, the same reference numerals as those of the respective components of manipulation equipment 100 described in the first exemplary embodiment are given to components that perform substantially the same operation as that in manipulation equipment 100, and individual descriptions are omitted.

Controller 42 that manipulation equipment 200 has is substantially the same as controller 22 described in the first exemplary embodiment. However, controller 42 can also compare a signal intensity transmitted from portable terminal 201 with a predetermined threshold, and give an instruction based on a result thereof to the respective components (blocks).

Portable terminal 201 includes controller 32, communicator 43, operator 34, and recorder 110. Since portable terminal 201 has substantially the same configuration and performs substantially the same operation as portable terminal 102 described in the first exemplary embodiment, detailed description thereof is omitted. In a block diagram of portable terminal 201 shown in FIG. 3, the same reference numerals as those of the respective components in portable terminal 102 described in the first exemplary embodiment are given to components that perform substantially the same operation as that of portable terminal 102, and individual descriptions thereof are omitted.

Communicator 43 that portable terminal 201 has is substantially the same as communicator 33 described in the first exemplary embodiment. However, communicator 43 can perform transmission/reception of radio signals with access point 202 of radio communication (e.g., Wi-Fi), and also measure a signal intensity of access point 202.

This communication means is not limited to Wi-Fi, but other communication means may be used.

In manipulation equipment 200 and portable terminal 201 in FIG. 3, only components (blocks) relating to operation described in the present exemplary embodiment are shown, and others are omitted.

Communicator 23 of manipulation equipment 200 may be configured to be able to communicate with access point 202, and communication between manipulation equipment 200 and portable terminal 201 may be performed via access point 202. Other communication means may be used for the communication between manipulation equipment 200 and portable terminal 201.

### [2-2. Operation]

One operation example of biometric authentication system 11 will be described below.

FIG. 4 is a flowchart showing the one operation example of biometric authentication system 11 in the second exemplary embodiment. In FIG. 4, one example of operation performed between portable terminal 201 and manipulation equipment 200 before first biometric information is transmitted from manipulation equipment 200 to portable terminal 201 is schematically shown. Operation when the biometric authentication is performed in biometric authentication system 11 is substantially the same as the operation described in the first exemplary embodiment, and thus, description thereof is omitted.

Manipulation equipment 200 inquires of portable terminal 201 about the intensity of the signal (the signal intensity) received by portable terminal 201 from access point 202 (step S300).

In step S300, information for identifying access point 202 (e.g., an SSID (Service Set IDentifier) of access point 202, or the like) is transmitted together with the inquiry from manipulation equipment 200 to portable terminal 201. This access point 202 is desirably installed in the vicinity of manipulation equipment 200.

Portable terminal 201 measures the signal intensity of access point 202 according to the instruction from manipulation equipment 200 in step S300 (step S301).

Portable terminal 201 answers the signal intensity measured in step S301 to manipulation equipment 200 (step S302).

Manipulation equipment 200 checks the signal intensity acquired from portable terminal 201 in step S302 (step S303). In step S303, manipulation equipment 200 compares the signal intensity acquired in step S302 with the predetermined threshold.

If it is determined that the signal intensity is higher than or equal to the threshold in step S303, manipulation equipment 200 determines that portable terminal 201 is in the vicinity of manipulation equipment 200, and that portable terminal 201 may be set as an object of communication, and continues subsequent processing (step S304). As in the first exemplary embodiment, manipulation equipment 200 transmits the first biometric information to portable terminal 201 and requests the collation between second biometric information recorded on portable terminal 201 and the first biometric information.

In step S303, if it is determined that the signal intensity is lower than the threshold, manipulation equipment 200 determines that portable terminal 201 is located away from manipulation equipment 200, and should not be set as the object of the communication, and ends the processing (step S305).

### [2-3. Effects and the Like]

As described above, in the present exemplary embodiment, the biometric authentication system has substantially the same configuration as biometric authentication system 10 described in the first exemplary embodiment, and can perform the biometric authentication of user 101.

Furthermore, in the biometric authentication system of the present exemplary embodiment, the terminal equipment is configured to be able to perform transmission/reception of the radio signals with the access point of the radio communication. The manipulation equipment is configured to inquire of the portable terminal about the signal intensity of the access point, and determine whether or not to continue the processing of the biometric authentication, based on the signal intensity answered from the terminal equipment.

In the present exemplary embodiment, biometric authentication system 11 is one example of the biometric authentication system, manipulation equipment 200 is one example of the manipulation equipment, portable terminal 201 is one example of the terminal equipment, and access point 202 is one example of the access point.

According to the present exemplary embodiment, manipulation equipment 200 can determine whether to continue or end the processing relating to the biometric authentication of user 101, based on the signal intensity of access point 202 measured in portable terminal 201.

This enables manipulation equipment 200 to limit the portable terminal to which manipulation equipment 200 is to request the biometric authentication to portable terminal 201 in the vicinity of manipulation equipment 200. Accordingly, the foregoing makes it possible that for example, at the time of payment using an electronic settlement terminal in a store, an object terminal of the settlement is limited to the portable terminal in the vicinity of the electronic settlement terminal.

### Third Exemplary Embodiment

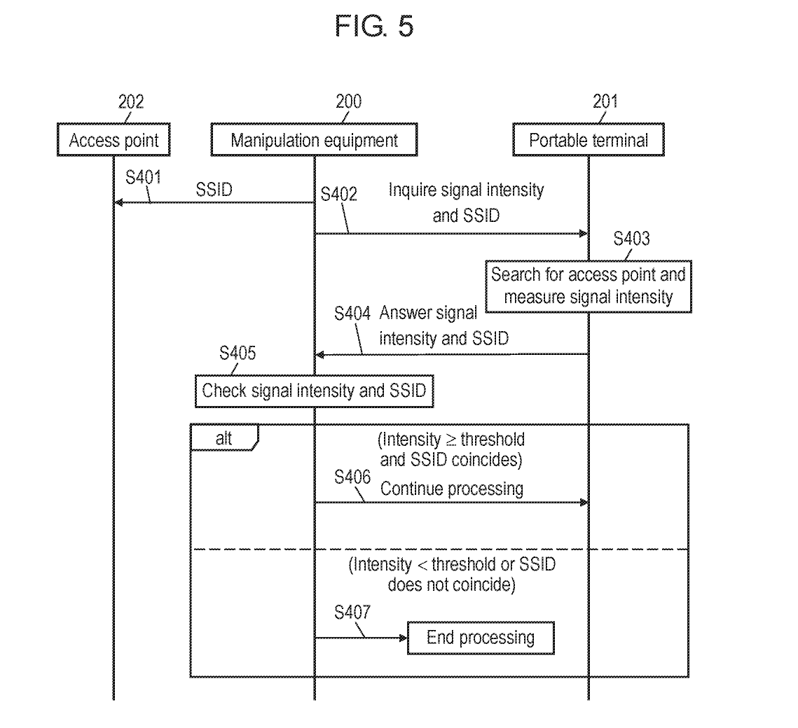

Next, a third exemplary embodiment will be described with reference to FIG. 5.

### [3-1. Configuration]

Since a biometric authentication system in the present exemplary embodiment has substantially the same configuration as biometric authentication system 11 described in the second exemplary embodiment, illustration and description thereof are omitted. However, manipulation equipment 200 in the present exemplary embodiment is further configured to generate an SSID and request setting of the SSID to access point 202 in addition to the configuration described in the second exemplary embodiment.

### [3-2. Operation]

FIG. 5 is a flowchart showing one operation example of the biometric authentication system in the third exemplary embodiment. In FIG. 5, one example of operation performed among portable terminal 201, manipulation equipment 200, and access point 202 before first biometric information is transmitted from manipulation equipment 200 to portable terminal 201 is schematically shown. Operation when biometric authentication is performed in the biometric authentication system in the present exemplary embodiment is substantially the same as the operation described in the first exemplary embodiment, ant thus, description thereof is omitted.

Manipulation equipment 200 generates the SSID and transmits the SSID to access point 202. The SSID is one example of first information. Manipulation equipment 200 requests access point 202 to change an SSID of access point 202 to the SSID transmitted from manipulation equipment 200 (step S401). Manipulation equipment 200 may generate this SSID in accordance with a predetermined procedure, or may generate it randomly. Moreover, the first information only needs to be information that enables access point 202 so as to be distinguished from another access point, and may be other than the SSID.

Manipulation equipment 200 inquires of portable terminal 201 about an intensity of a signal (a signal intensity) that portable terminal 201 receives from access point 202, and the SSID (the first information) set in access point 202 (step S402).

In step S402, second information for identifying access point 202 is transmitted together with the inquiry from manipulation equipment 200 to portable terminal 201. This second information is information for identifying access point 202 whose SSID is requested to change in step S401, and is, for example, a MAC address of access point 202. The MAC address is one example of the second information, and the second information only needs to be information that enables access point 202 to be distinguished from any other access point, and may be other than the MAC address.

Portable terminal 201 searches for access point 202, based on the second information (e.g., the MAC address) for identifying access point 202 received from manipulation equipment 200 in step S402. The SSID set in relevant access point 202 is read out, and the signal intensity of access point 202 is measured (step S403). A series of processing in step S403 can be implemented, using a generally used technique, and thus, detailed description thereof is omitted.

Portable terminal 201 answers the SSID and the signal intensity acquired in step S403 to manipulation equipment 200 (step S404).

If the search for access point 202 fails in step S403, portable terminal 201 answers the failure in the search to manipulation equipment 200.

Manipulation equipment 200 checks the signal intensity and the SSID acquired from portable terminal 201 in step S404 (step S405).

In step S405, manipulation equipment 200 checks whether or not the two SSIDs of the SSID acquired from portable terminal 201 in step S404 and the SSID transmitted to access point 202 from manipulation equipment 200 in step S401 coincide with each other. Moreover, manipulation equipment 200 compares the signal intensity acquired from portable terminal 201 in step S404 with the predetermined threshold.

If in step S405, it is determined that the signal intensity is higher than or equal to the threshold, and that the two SSIDs coincide with each other, manipulation equipment 200 determines that portable terminal 201 is in the vicinity of manipulation equipment 200, and may be set as the object of the communication, and continues subsequent processing (step S406). As in the first exemplary embodiment, manipulation equipment 200 transmits the first biometric information to portable terminal 201, and requests the collation between second biometric information recorded on portable terminal 201 and the first biometric information.

If in step S405, when at least one of determinations that the signal intensity is lower than the threshold and that the two SSIDs do not coincide with each other is made, manipulation equipment 200 determines that relevant portable terminal 201 is located away from manipulation equipment 200, and should not be set as the object of the communication, and ends the processing (step S407).

When the failure in the search for access point 202 in step S404 is answered from portable terminal 201 as well, manipulation equipment 200 determines that relevant portable terminal 201 is located away from manipulation equipment 200 and should not be set as the object of the communication, and ends the processing.

### [3-3. Effects and the Like]

As described above, in the present exemplary embodiment, the biometric authentication system has the substantially similar configuration to that of biometric authentication system 10 described in the first exemplary embodiment, and can perform the biometric authentication of user 101.

Furthermore, in the biometric authentication system of the present exemplary embodiment, the terminal equipment is configured to be able to perform transmission/reception of the radio signals with the access point of the radio communication. The manipulation equipment is configured to generate the first information for setting in the access point, request setting of the first information to the access point, transmit the second information for identifying the access point to the terminal equipment, inquire of the terminal equipment about the signal intensity of the access point and the first information set in the access point, and determine whether or not to continue the processing of the biometric authentication, based on the signal intensity and the first information answered from the terminal equipment.

The biometric authentication system described in the present exemplary embodiment is one example of the above-described biometric system, manipulation equipment 200 is one example of the manipulation equipment, portable terminal 201 is one example of the terminal equipment, access point 202 is one example of the access point, the SSID is one example of the first information, and the MAC address is one example of the second information.

According to the present exemplary embodiment, manipulation equipment 200 can determine whether to continue or end the processing relating to the biometric authentication of user 101, based on the signal intensity of access point 202 and the first information answered from portable terminal 201.

Determination as to whether or not the signal intensity of access point 202 measured in portable terminal 201 is taken from a radio wave sent from access point 202 may be difficult. For example, when even if portable terminal 201 is out of a radio wave reachable range of access point 202, when portable terminal 201 can communicate with another access point connected to a network to which access point 202 is connected, portable terminal 201 may perform communication with the other access point without distinguishing the relevant communication from the communication with access point 202. When the access point is installed at a position away from access point 202, relevant portable terminal 201 is not desirable as a communication partner of manipulation equipment 200.

However, in the present exemplary embodiment, since access point 202 is identified, based on the first information and the second information, the above-described problem is prevented from occurring.

In this manner, according to the present exemplary embodiment, manipulation equipment 200 can perform the determination as to whether to continue or end the processing relating to the biometric authentication of user 101, based on the signal intensity of access point 202 measured in portable terminal 201, and the SSID of access point 202 acquired in portable terminal 201.

This enables manipulation equipment 200 to limit the portable terminal to which manipulation equipment 200 is to request the biometric authentication to portable terminal 201 in the vicinity of manipulation equipment 200. Accordingly, the foregoing makes it possible that for example, at the time of payment using an electronic settlement terminal in a store, an object terminal of the settlement is limited to the portable terminal near the electronic settlement terminal.

### Fourth Exemplary Embodiment

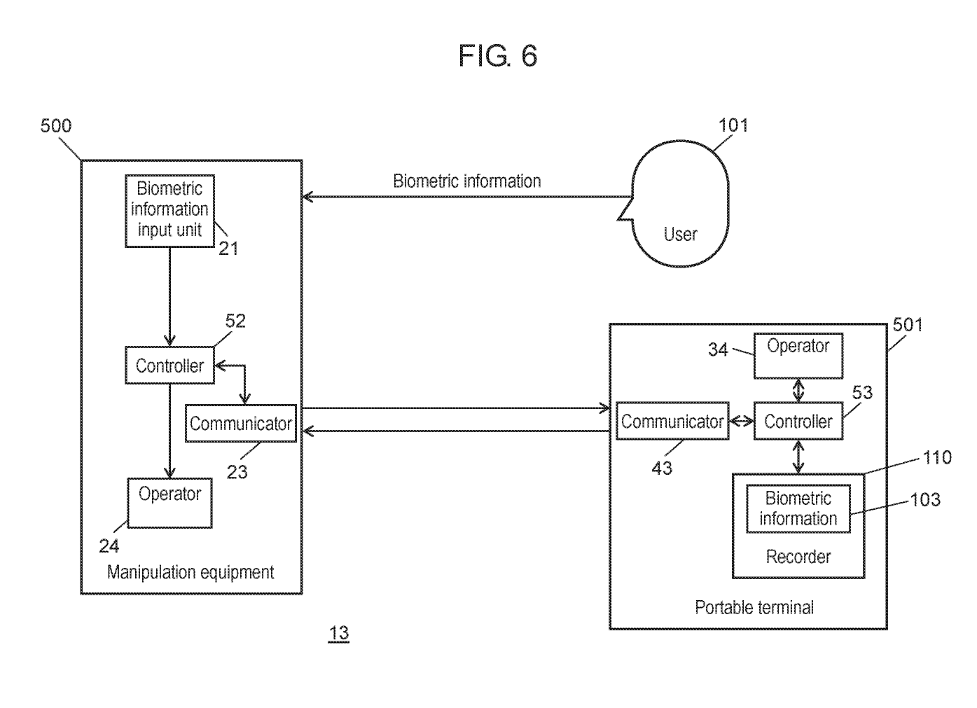

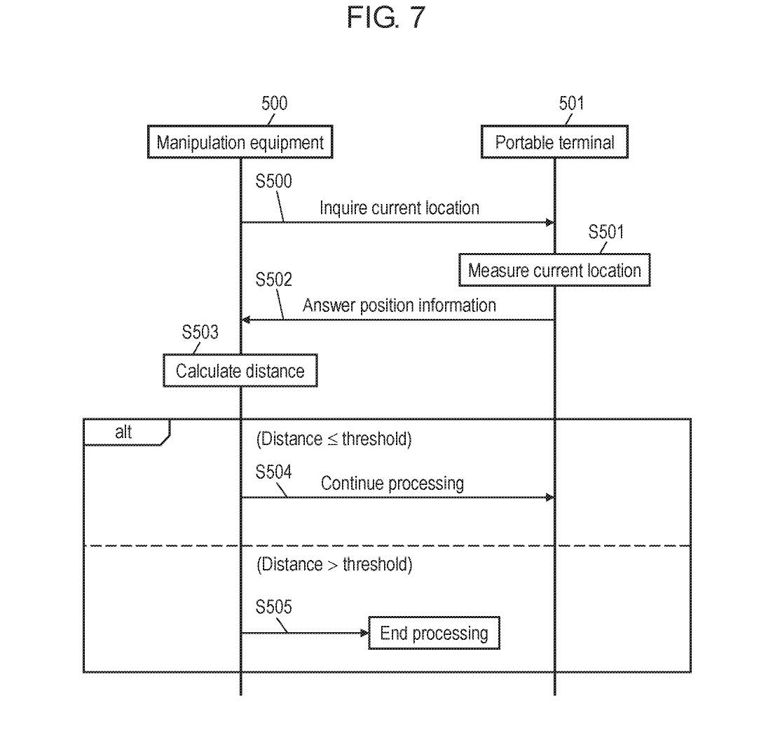

In the second and third exemplary embodiments, the biometric authentication system in which continuation/end of the processing is determined in manipulation equipment 200, based on the signal intensity of access point 202 measured in portable terminal 201 has been described. In a fourth exemplary embodiment, a biometric authentication system in which continuation/end of processing is determined in manipulation equipment 200, based on position information of portable terminal 201 itself obtained in portable terminal 201 will be described with reference to FIGS. 6 and 7.

### [4-1. Configuration]

FIG. 6 is a diagram schematically showing one configuration example of biometric authentication system 13 in the fourth exemplary embodiment.

As shown in FIG. 6, biometric authentication system 13 includes portable terminal 501 and manipulation equipment 500 configured to be able to communicate with each other. Portable terminal 501 is one example of terminal equipment.

Manipulation equipment 500 includes biometric information input unit 21, controller 52, communicator 23, and operator 24. Manipulation equipment 500 has substantially the same configuration and performs substantially the same operation as manipulation equipment 200 described in the second exemplary embodiment, and, and thus, detailed description thereof is omitted. Moreover, in a block diagram of manipulation equipment 500 shown in FIG. 6, the same reference numerals as those of the respective components of manipulation equipment 200 described in the second exemplary embodiment are given to components that perform substantially the same operation as that in manipulation equipment 200, and individual descriptions thereof are omitted.

Controller 52 that manipulation equipment 500 has is substantially the same as controller 42 described in the second exemplary embodiment. However, controller 52 can also calculate a distance between manipulation equipment 500 and portable terminal 501, based on position information transmitted from portable terminal 501 and position information of manipulation equipment 500 itself, compare the calculated distance with a predetermined threshold, and send an instruction based on a result of the comparison to the respective components (blocks).

Portable terminal 501 includes controller 53, communicator 43, operator 34, and recorder 110. Since portable terminal 501 has substantially the same configuration and performs substantially the same operation as portable terminal 201 described in the second exemplary embodiment, detailed description thereof is omitted. In a block diagram of portable terminal 501 shown in FIG. 6, the same reference numerals as those of the respective components of portable terminal 201 described in the second exemplary embodiment are given to components that perform substantially the same operation as that of portable terminal 201, and individual descriptions thereof are omitted.

Controller 53 that portable terminal 501 has is substantially the same as controller 32 described in the second exemplary embodiment. However, controller 53 can also measure a current location of portable terminal 501 itself, and transmit the position information to manipulation equipment 500 through communicator 43.

In manipulation equipment 500 and portable terminal 501 in FIG. 6, only components (blocks) relating to operation described in the present exemplary embodiment are shown, and others are omitted.

### [4-2. Operation]

FIG. 7 is a flowchart showing one operation example of biometric authentication system 13 in the fourth exemplary embodiment. In FIG. 7, one example of operation performed between portable terminal 501 and manipulation equipment 500 before first biometric information is transmitted from manipulation equipment 500 to portable terminal 501 is schematically shown. Operation when biometric authentication is performed in biometric authentication system 13 in the present exemplary embodiment is substantially the same as the operation described in the first exemplary embodiment, and thus, description thereof is omitted.

Manipulation equipment 500 inquires of portable terminal 501 about the current location of portable terminal 501 (step S500).

Portable terminal 501 measures its own current location, based on the inquiry in step S500 (step S501). The measurement of the current location can be implemented, using a generally used position measurement technique such as a position detection system using a beacon, a GPS (Global Positioning System) and the like, and thus, detailed description thereof is omitted.

Portable terminal 501 answers the position information of its own current location measured in step S501 to manipulation equipment 500 (step S502).

If the measurement of the current location fails in step S501, portable terminal 501 answers the failure in the measurement of the current location to manipulation equipment 500.

Manipulation equipment 500 calculates the distance between manipulation equipment 500 and portable terminal 501, based on the position information of manipulation equipment 500 itself, and the position information of portable terminal 501 acquired in step S502. The calculated distance is then compared with the predetermined threshold (step S503).

In step S503, when it is determined that the distance between manipulation equipment 500 and portable terminal 501 is smaller than or equal to the threshold, manipulation equipment 500 determines that relevant portable terminal 501 is in the vicinity of manipulation equipment 500, and may be set as an object of communication, and continues subsequent processing (step S504). As in the first exemplary embodiment, manipulation equipment 500 transmits the first biometric information to portable terminal 501, and requests collation between second biometric information recorded on portable terminal 501 and the first biometric information.

In step S03, when it is determined that the distance between manipulation equipment 500 and portable terminal 501 is larger than the threshold, manipulation equipment 500 determines that relevant portable terminal 501 is located away from manipulation equipment 500, and should not be set as the object of the communication, and ends the processing (step S505).

When the failure in the measurement of the current location in step S502 is answered from portable terminal 501, manipulation equipment 500 also determines that relevant portable terminal 501 should not be set as the object of the communication, and ends the processing.

### [4-3. Effects and the Like]

As described above, in the present exemplary embodiment, the biometric authentication system has the substantially similar configuration to that of biometric authentication system 10 described in the first exemplary embodiment, and can perform the biometric authentication of user 101.

Furthermore, in the biometric authentication system of the present exemplary embodiment, the terminal equipment is configured to be able to measure the current location of the terminal equipment itself. The manipulation equipment is configured to inquire of the terminal equipment about the current location of the terminal equipment, calculate the distance between the manipulation equipment and the terminal equipment, based on the position information answered from the terminal equipment and the position information of the manipulation equipment itself, and determine whether or not to continue processing of the biometric authentication, based on the calculated distance.

The biometric authentication system described in the present exemplary embodiment is one example of the above-described biometric authentication system, manipulation equipment 500 is one example of the manipulation equipment, and portable terminal 501 is one example of the terminal equipment.

According to the present exemplary embodiment, manipulation equipment 500 can determine whether or not portable terminal 501 is in the vicinity of manipulation equipment 500, based on the position information answered from portable terminal 501 and determine whether to continue or end the processing relating to the biometric authentication of user 101.

This enables manipulation equipment 500 to limit the portable terminal to which the manipulation equipment 500 is to request the biometric authentication to portable terminal 501 in the vicinity of manipulation equipment 500. Accordingly, the foregoing makes it possible that for example, at the time of payment using an electronic settlement terminal in a store, an object terminal of the settlement is limited to a portable terminal near the electronic settlement terminal.

### Fifth Exemplary Embodiment

In a fifth exemplary embodiment, a biometric authentication system configured to perform biometric authentication of a user, using a voiceprint, which is one of types of biometric information, will be described. Manipulation equipment included by this biometric authentication system is configured to be able to simultaneously perform equipment manipulation based on an uttered voice command and personal authentication based on a voice (a voiceprint) of the user when the user utters the voice command registered beforehand as an equipment manipulation command.

The manipulation equipment included by this biometric authentication system has a function of enabling the user to telephone to a partner designated by the user. For example, if the user utters “telephone” together with a personal name, or a popular name or an abbreviation by which an individual can be identified to the manipulation equipment, the manipulation equipment is configured to perform the personal authentication of the user by a voice (a voiceprint), search for a telephone number of the designated partner, based on the uttered voice command if the personal authentication has succeeded, and call the searched telephone number.

The above-described function of telephoning to the designated partner can be implemented, using a generally used technique, and thus, detailed description thereof is omitted.

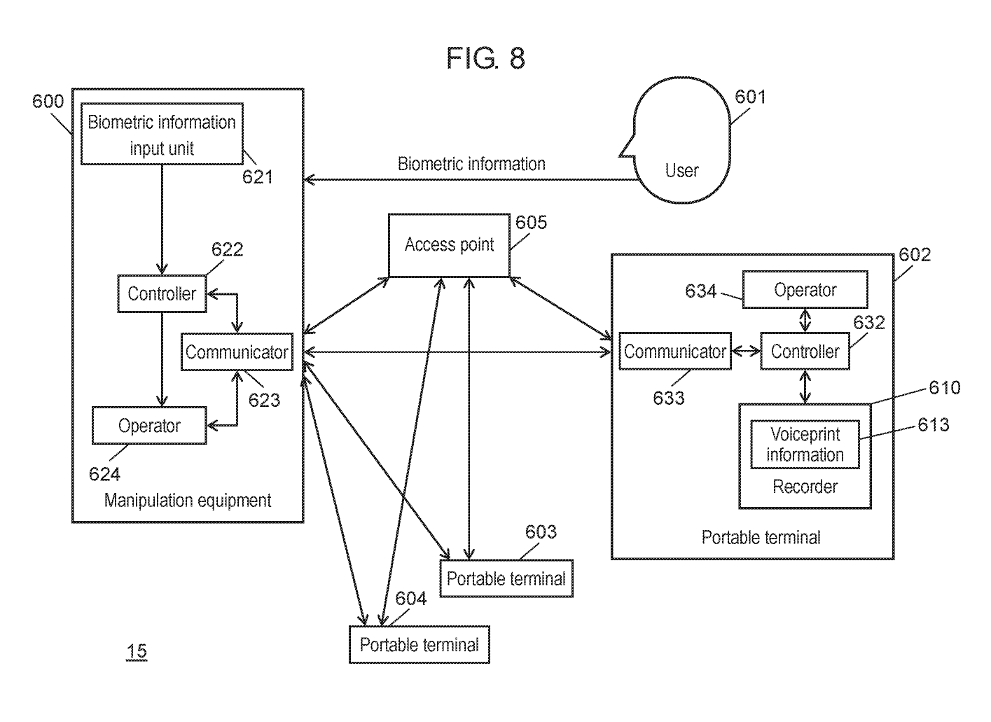

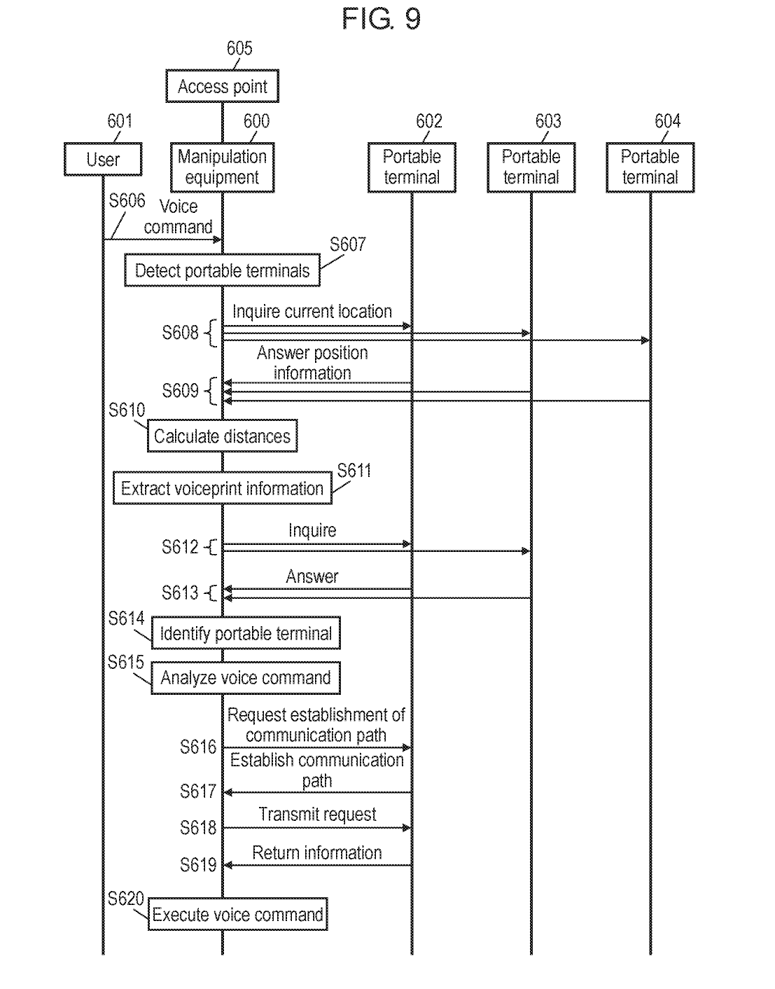

Hereinafter, the fifth exemplary embodiment will be described with reference to FIGS. 8 and 9.

### [5-1. Configuration]

FIG. 8 is a diagram schematically showing one configuration example of biometric authentication system 15 in the fifth exemplary embodiment.

As shown in FIG. 8, biometric authentication system 15 in the present exemplary embodiment includes manipulation equipment 600 and a plurality of portable terminals (e.g., portable terminals 602, 603, and 604), which are configured to be able to communicate with each other. Portable terminals 602, 603, and 604 are examples of terminal equipment. A number of the portable terminal included by biometric authentication system 15 may be singular.

Portable terminals 603 and 604 each have substantially the same configuration as that of portable terminal 602, and thus, FIG. 8 shows only a block diagram of portable terminal 602.

Manipulation equipment 600 includes biometric information input unit 621, controller 622, communicator 623, and operator 624. Manipulation equipment 600 is configured to perform personal authentication of user 601, based on a voiceprint of user 601, and start subsequent operation if as a result of the personal authentication, it is determined that user 601 is a specific individual registered beforehand. This voiceprint is one example of first biometric information.

Portable terminal 602 includes controller 632, communicator 633, operator 634, and recorder 610. Portable terminal 602 is a terminal formed in size capable of being carried by user 601, and is, for example, a portable telephone or a smartphone. However, the present exemplary embodiment does not limit portable terminal 602 to these, but portable terminal 602 may be other equipment.

In manipulation equipment 600 and portable terminal 602 in FIG. 8, only components (blocks) relating to operation described in the present exemplary embodiment are shown, and others are omitted.

Manipulation equipment 600 and portable terminal 602 are configured so as to be able to communicate with each other by radio through communicator 623 and communicator 633. However, in the present exemplary embodiment, the communication method is not limited to the radio communication, but wired communication in which communicator 623 and communicator 633 are connected by cable may be performed. Since the communication performed by communicator 623 and communicator 633 can be implemented, using a generally used communication technique, detailed description thereof is omitted.

Manipulation equipment 600 is configured to be able to transmit and receive radio signals with access point 605 of radio communication (e.g., Wi-Fi) through communicator 623. This communication means is not limited to Wi-Fi, but other communication means may be used. Moreover, access point 605 is substantially the same as access point 202 described in the second exemplary embodiment.

Operator 624 is a device configured with substantially the same function as that of a generally used call terminal. Operator 624 is configured to operate, based on an instruction of permitting/not permitting of operation output from controller 622. Manipulation equipment 600 is not limited to the call terminal. Manipulation equipment 600 may be any device configured to be able to telephone, based on the result of the personal authentication.

Biometric information input unit 621 is configured such that the voiceprint of user 601 can be input thereto as first biometric information. Biometric information input unit 621 is configured with a function as a microphone, configured to be able to acquire a voice uttered by user 601, create voiceprint information from the acquired voice, and set the voiceprint information as the first biometric information. The creation of the voiceprint information based on the voice can be implemented, using a generally used technique, and thus, detailed description thereof is omitted.

Controller 622 is configured to transmit the first biometric information output from biometric information input unit 621 to portable terminal 602 through communicator 623, and instruct permitting/not permitting of the operation to operator 624, based on a collation result returned from portable terminal 602. Controller 622 may control a display unit (not shown) to notify user 601 of success/failure in the personal authentication, based on the collation result.

Moreover, controller 622 is configured with a voice recognition function to perform various types of control, based on the voice commands uttered by the user. Accordingly, user 601 can perform manipulation (voice manipulation) to manipulation equipment 600 by the voice of user 601. For example, user 601 can telephone to a specific partner from manipulation equipment 600 by the voice manipulation. User 601, for example, can use the microphone function that biometric information input unit 621 has, and input the voice command to manipulation equipment 600. The voice recognition function that controller 622 has can be implemented, using a generally used voice recognition technique, and thus, detailed description thereof is omitted.

Voiceprint information 613 of user 601 is recorded beforehand in recorder 610 of portable terminal 602 as second biometric information. Recorder 610 is, for example, a semiconductor memory, and is configured such that writing/reading of data can be arbitrarily performed. Recorder 610 is not limited to the semiconductor memory, but may be configured by another storage device such as a hard disk, or the like.

Communicator 633 is configured to output the first biometric information transmitted from manipulation equipment 600 to controller 632 upon receiving the first biometric information.

Controller 632 is configured to read out voiceprint information 613 recorded in recorder 610, upon receiving the first biometric information, collate voiceprint information 613 with the first biometric information, and transmit the collation result to manipulation equipment 600 through communicator 633. This collation can be implemented, using a generally used method for collating both the pieces of the voiceprint information, and thus, detailed description thereof is omitted.

Operator 634 is configured to execute general operation of portable terminal 602 (e.g., general operation as a portable telephone, general operation as a smartphone, or the like). Moreover, operator 634 is configured to be able to acquire position information of a current location of portable terminal 602 itself. The operation of operator 634 is substantially the same as the above-mentioned generally known operation, and thus, detailed description thereof is omitted.

Moreover, portable terminal 602 is configured to be able to transmit and receive radio signals with access point 605 through communicator 623.

Respective components (blocks) shown in FIG. 8 may be configured as electronic circuits, or may be configured to be implemented by executing a program in a processor.

### [5-2. Operation]

One operation example of biometric authentication system 15 configured as described above will be described below.

FIG. 9 is a flowchart showing one operation example of biometric authentication system 15 in the fifth exemplary embodiment. In FIG. 9, one operation example of biometric authentication system 15 when user 601 utters the voice command to telephone to a particular partner is shown.

In the operation example shown in FIG. 9, it is supposed that voiceprint information 613 of user 601 is registered beforehand in portable terminal 602 as the second biometric information. Moreover, it is supposed that the second biometric information registered beforehand in respective portable terminals 603 and 604 is not the voiceprint information of user 601. Moreover, it is supposed that portable terminal 602 and portable terminal 603 are in the vicinity of manipulation equipment 600, and portable terminal 604 is located away from manipulation equipment 600. Moreover, it is supposed that access point 605 is connected to manipulation equipment 600 by radio, and can be used for a communication path when manipulation equipment 600 detects the portable terminal or performs inquiry.

The voice command uttered to manipulation equipment 600 by user 601 is input to manipulation equipment 600 (step S606). In the present exemplary embodiment, operation when user 601 utters “telephone to my wife” as one example of the voice command will be described. The voice command is not limited thereto.

Manipulation equipment 600 detects the portable terminals to which the biometric authentication can be requested (step S607).

Manipulation equipment 600 detects the portable terminals to which the biometric authentication can be requested by detecting, through access point 605, the portable terminals connected to access point 605 or the like. However, a method for detecting the portable terminals in manipulation equipment 600 is not limited to this method.

In the operation example shown in FIG. 9, it is supposed that the three portable terminals of portable terminal 602, portable terminal 603, and portable terminal 604 are detected in step S607.

Manipulation equipment 600 inquires a current location of each of the portable terminals detected in step S607 (in the example shown in FIG. 9, portable terminals 602, 603, and 604) (step S608). In step S608, substantially the same processing as step S500 described in the fourth exemplary embodiment is performed.

The portable terminals that have received the inquiry in step S608 (in the example shown in FIG. 9, the portable terminals 602, 603, and 604) measure their own current locations, based on the inquiry. The portable terminals (in the example shown in FIG. 9, portable terminals 602, 603, and 604) answer the position information of their own measured current locations to manipulation equipment 600 (step S609). In step S609, substantially the same processing as steps S501 and S502 described in the fourth exemplary embodiment is performed.

Manipulation equipment 600 calculates a distance between manipulation equipment 600 and each of the portable terminals (in the example shown in FIG. 9, a distance between manipulation equipment 600 and each of portable terminals 602, 603, and 604), based on position information of manipulation equipment 600 itself and the position information acquired in step S609 (in the example shown in FIG. 9, the position information of each of portable terminals 602, 603, and 604). Each of the calculated distances and a predetermined threshold are then compared. Manipulation equipment 600 determines the portable terminals at distances which are smaller than or equal to the threshold as objects to which the processing is continued, and ends the processing with the portable terminal at a distance which is larger than the threshold (step S610).

In step S610, substantially the same processing as steps S503, S504, and S505 described in the fourth exemplary embodiment is performed. In the present exemplary embodiment, operation when in step S610, it is determined that as to the portable terminal 602 and portable terminal 603, the distances from manipulation equipment 600 are smaller than or equal to the threshold, so that the processing can be continued, and as to portable terminal 604, the distance from manipulation equipment 600 is larger than the threshold, so that the processing should be ended will be described.

Manipulation equipment 600 extracts the voiceprint information from the voice uttered by user 601 (step S611).

Manipulation equipment 600 transmits the voiceprint information (the first biometric information) extracted in step S611 to the portable terminals which are determined in step S610 that the processing can be continued (in the example shown in FIG. 9, portable terminal 602 and portable terminal 603), and inquires whether or not the voiceprint information coincides with voiceprint information 613 registered beforehand (the second biometric information) (step S612).

The portable terminals that have received the inquiry in step S612 (in the example shown in FIG. 9, portable terminals 602 and 603) collate the voiceprint information (the first biometric information) transmitted from manipulation equipment 600 with voiceprint information 613 (the second biometric information) registered beforehand inside the portable terminals. Collation results are then answered to manipulation equipment 600 (step S613).

In steps S612 and S613, substantially the same processing as steps S102, S103, and S104 described in the first exemplary embodiment is performed.

Manipulation equipment 600 identifies the portable terminal that has answered coincidence in step S613. Manipulation equipment 600 continues the processing to the portable terminal that has answered the coincidence, and ends the processing to the portable terminal that has answered incoincidence (step S614).

In the present exemplary embodiment, the operation example in which portable terminal 602 has answered the coincidence and portable terminal 603 has answered the incoincidence to manipulation equipment 600 is described. Accordingly, in the example shown in FIG. 9, manipulation equipment 600 continues the processing to portable terminal 602, and ends the processing to portable terminal 603.

Manipulation equipment 600 analyzes the voice command of user 601 input to manipulation equipment 600 in step S606, and converts the voice command to a character string (step S615).

Voice recognition processing in step S615 can be implemented, using a generally used voice recognition technique, and thus, detailed description thereof is omitted. While in the present exemplary embodiment, an operation example in which a character string of “telephone to my wife” is obtained by the processing in step S615 will be described, the present disclosure is not limited thereto.

In the operation example shown in FIG. 9, manipulation equipment 600 determines that it is requested by user 601 to telephone to an individual with a name of “my wife”. Here, it is supposed that a telephone number of “my wife” is not registered in manipulation equipment 600. In this case, manipulation equipment 600 operates so as to acquire necessary information (here, the telephone number of “my wife”) from portable terminal 602. When acquiring information with high confidentiality such as personal information and the like, manipulation equipment 600 is set beforehand so as to use a secure communication path. Based on this setting, manipulation equipment 600 transmits an establishment request of the communication path (e.g., WebSocket connection or the like) to portable terminal 602 (step S616), and establishes the communication path with portable terminal 602 (step S617).

Manipulation equipment 600 transmits a request to portable terminal 602 through the communication path (e.g., the WebSocket connection) established in step S617 (step S618). While in the example described in the present exemplary embodiment, this request is made for the telephone number associated with “my wife”, the present disclosure is not limited thereto.

Based on the request transmitted from manipulation equipment 600 in step S618, portable terminal 602 searches for information corresponding to the request, and returns the information obtained as a result of the search to manipulation equipment 600 (step S619).

Manipulation equipment 600 uses the information obtained in step S619, and executes the operation based on the analysis result of the voice command obtained in step S615 (the operation based on the voice manipulation of user 601) (step S620). In the example described in the present exemplary embodiment, manipulation equipment 600 executes the operation of telephoning to the telephone number obtained in step S619.

If there is no shortage of the information when manipulation equipment 600 executes the operation based on the voice command, the processing in steps S616 to S619 is unnecessary.

### [5-3. Effects and the Like]

As described above, in the present exemplary embodiment, the biometric authentication system has a substantially similar configuration to that of biometric authentication system 10 described in the first exemplary embodiment, and can perform the biometric authentication of user 601.

Furthermore, in the present exemplary embodiment, the biometric authentication system includes the plurality of pieces of terminal equipment each configured to be able to measure the current location of the terminal equipment itself. The manipulation equipment is configured to be able to mutually communicate with each of the plurality of pieces of terminal equipment. The manipulation equipment is configured to inquire of each of the plurality of pieces of terminal equipment about the current location of the relevant terminal equipment itself, calculate the respective distance between the manipulation equipment and the relevant terminal equipment, based on the position information answered from the relevant terminal equipment and the position information of the manipulation equipment itself, and decide the terminal equipment to which the first biometric information is to be transmitted, based on the calculated distance.

In the present exemplary embodiment, biometric authentication system 15 is one example of the above-described biometric authentication system, manipulation equipment 600 is one example of the manipulation equipment, portable terminals 602, 603, and 604 are examples of the terminal equipment, and the voiceprint information is one example of the biometric information.

According to the present exemplary embodiment, manipulation equipment 600 can select the portable terminal in the vicinity of manipulation equipment 600, based on the position information answered from the plurality of portable terminals, and request the biometric authentication of user 601 to the selected portable terminal.

This enables manipulation equipment 600 to limit the portable terminal to which the biometric authentication is to be requested to portable terminals 602 and 603 in the vicinity of manipulation equipment 600. Furthermore, manipulation equipment 600 is enabled to establish the communication path with portable terminal 602, which has succeeded in the biometric authentication, and obtain the necessary information from portable terminal 602.

In this configuration, for example, even when a plurality of persons use the manipulation equipment configured to perform voice recognition, the manipulation equipment can perform the personal authentication of the users accurately, and execute the operation based on the voice manipulation of the users accurately.

### Sixth Exemplary Embodiment

In a sixth exemplary embodiment, a biometric authentication system configured to perform biometric authentication of a user, using a voiceprint as one of types of biometric information as in the fifth exemplary embodiment will be described. Similar to manipulation equipment 600 described in the fifth exemplary embodiment, manipulation equipment included by the biometric authentication system in the present exemplary embodiment is configured to be able to simultaneously perform equipment manipulation based on an uttered voice command, and personal authentication based on a voice (a voiceprint) of the user when the user utters the voice command registered beforehand as an equipment manipulation command.

However, the manipulation equipment included by the biometric authentication system described in the present exemplary embodiment is different from the fifth exemplary embodiment in that the manipulation equipment is configured to control opening/closing of a door (or locking/unlocking of the door), based on voice manipulation of the user. This manipulation equipment is configured to perform the personal authentication of the user by means of the voice (the voiceprint) when the user utters the voice command (e.g., “open” or the like) instructing to open the door (or unlock the door), and open the door (or unlock the door), based on the uttered voice command if the personal authentication has succeeded.

The above-described function for control of opening and closing of the door (or locking/unlocking of the door) can be implemented, using a generally used technique, and thus, detailed description thereof is omitted.

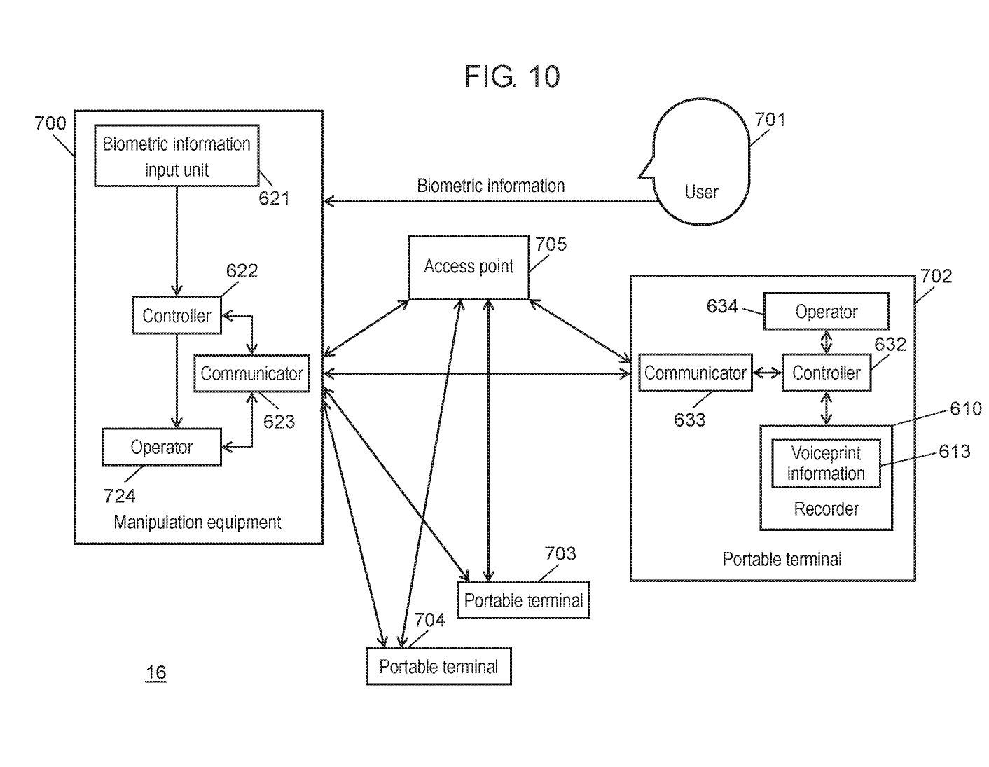

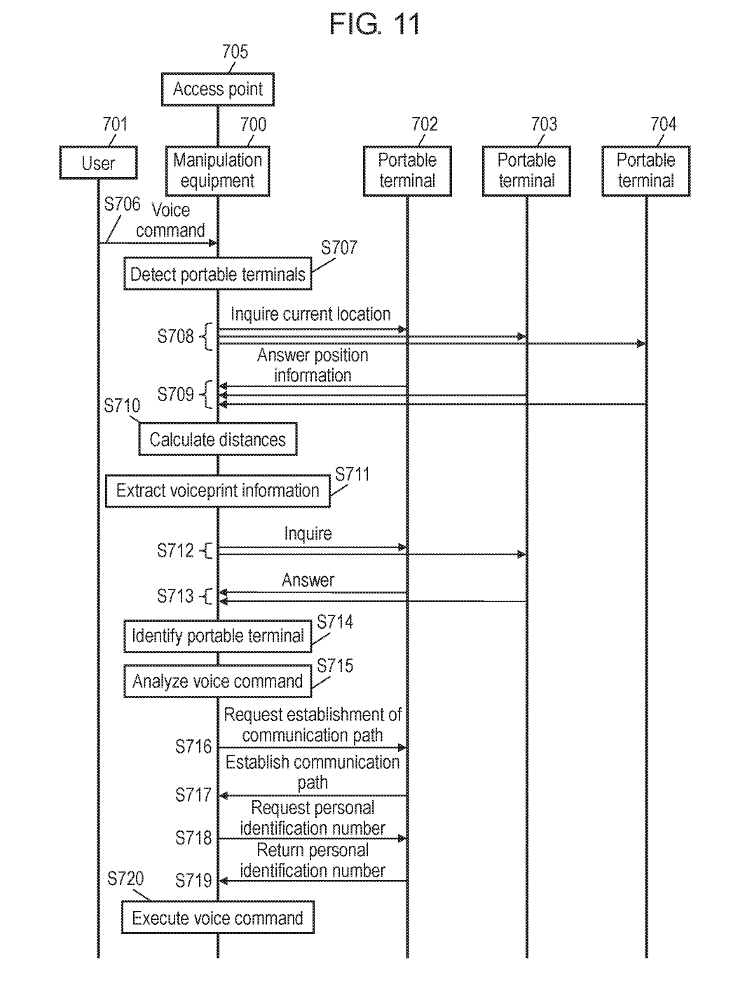

Hereinafter, the sixth exemplary embodiment will be described with reference to FIGS. 10 and 11.

### [6-1. Configuration]

FIG. 10 is a diagram schematically showing one configuration example of biometric authentication system 16 in the sixth exemplary embodiment.

As shown in FIG. 10, biometric authentication system 16 in the present exemplary embodiment includes manipulation equipment 700, and portable terminals 702, 703, and 704, which are configured to be able to communicate with each other. Portable terminals 702, 703, and 704 are examples of terminal equipment.

Portable terminals 703 and 704 each have substantially the same configuration as that of portable terminal 702, and thus, FIG. 10 shows only a block diagram of portable terminal 702.

As to manipulation equipment 700, and portable terminal 702 in FIG. 10, only components (blocks) relating to operation described in the present exemplary embodiment are shown, and others are omitted.

Manipulation equipment 700 includes biometric information input unit 621, controller 622, communicator 623, and operator 724, and is configured to be able to transmit and receive radio signals with access point 705 of radio communication (e.g., Wi-Fi) through communicator 623. This communication means is not limited to Wi-Fi, but other communication means may be used. Moreover, access point 705 is substantially the same as access point 605 described in the fifth exemplary embodiment.

In the block diagram of manipulation equipment 700 shown in FIG. 10, the same reference numerals as those of the respective components of manipulation equipment 600 described in the fifth exemplary embodiment are given to components that perform substantially the same operation as that of manipulation equipment 600, and description thereof is omitted.

Manipulation equipment 700 is configured to control the opening/closing of the door (or locking/unlocking of the door), based on the biometric authentication of user 701 so that only user 701 registered beforehand can open the door (not shown). That is, operator 724 of manipulation equipment 700 is different from operator 624 of manipulation equipment 600 described in the fifth exemplary embodiment in that operator 724 is configured to perform the opening/closing (or the locking/unlocking of the door). However, except for this point, manipulation equipment 700 has substantially the same configuration and performs substantially the same operation as manipulation equipment 600 described in the fifth exemplary embodiment, and thus, detailed description of manipulation equipment 700 is omitted.

Portable terminal 702 includes controller 632, communicator 633, operator 634, and recorder 610, and is configured to be able to transmit and receive the radio signals with access point 705 through communicator 623. In the block diagram of portable terminal 702 shown in FIG. 10, the same reference numerals as those of the respective components of portable terminal 602 described in the fifth exemplary embodiment are given to components that perform substantially the same operation as that of portable terminal 602, and thus, description thereof is omitted.

Portable terminal 702 in the present exemplary embodiment has substantially the same configuration and performs substantially the same operation as portable terminal 602 described in the fifth exemplary embodiment, and thus, detailed description of portable terminal 702 is omitted.

Respective components (blocks) shown in FIG. 10 may be configured as electronic circuits, or may be configured to be implemented by executing a program in a processor.

### [6-2. Operation]

One operation example of biometric authentication system 16 configured as described above will be described below.

FIG. 11 is a flowchart showing the one operation example of biometric authentication system 16 in the sixth exemplary embodiment. FIG. 11 shows one operation example of biometric authentication system 16 when user 701 utters the voice command to open the door.

In the operation example shown in FIG. 11, it is supposed that voiceprint information 613 of user 701 is registered beforehand in portable terminal 702 as second biometric information. Moreover, it is supposed that the second biometric information registered beforehand in respective portable terminals 703 and 704 is not voiceprint information of user 701. Moreover, it is supposed that portable terminal 702 and portable terminal 703 are in the vicinity of manipulation equipment 700, and portable terminal 704 is located away from manipulation equipment 700. Moreover, it is supposed that access point 705 is connected to manipulation equipment 700 by radio, and can be used for a communication path when manipulation equipment 700 detects the portable terminal or performs inquiry.

The voice command uttered to manipulation equipment 700 by user 701 is input to manipulation equipment 700 (step S706). In the present exemplary embodiment, operation when user 701 utters “open” as one example of the voice command will be described. While this voice command is one example of the command to open the door (or unlock the door), the voice command is not limited thereto.

Manipulation equipment 700 detects the portable terminals to which the biometric authentication can be requested (step S707). In step S707, substantially the same processing as step S607 described in the fifth exemplary embodiment is performed.

In the operation example shown in FIG. 11, it is supposed that the three portable terminals of portable terminal 702, portable terminal 703, and portable terminal 704 are detected in step S707.

Manipulation equipment 700 inquires a current location of each of the portable terminals detected in step S707 (in the example shown in FIG. 11, portable terminals 702, 703, and 704) (step S708). In step S708, substantially the same processing as step S608 described in the fifth exemplary embodiment is performed.

The portable terminals that have received the inquiry in step S708 (in the example shown in FIG. 11, portable terminals 702, 703, and 704) measure their own current locations, based on the inquiry, and answer position information of their own measured current locations to manipulation equipment 700 (step S709). In step S709, substantially the same processing as step S609 described in the fifth exemplary embodiment is performed.

Manipulation equipment 700 calculates each distance between manipulation equipment 700 and each of the portable terminals (in the example shown in FIG. 11, a distance between manipulation equipment 700 and each of portable terminals 702, 703, and 704), based on position information of manipulation equipment 700 itself and the position information acquired in step S709 (in the example shown in FIG. 11, each piece of position information of portable terminals, 702, 703, and 704). Then, manipulation equipment 700 compares each of the calculated distances with a predetermined threshold, and distinguishes the portable terminal in which the processing is to be continued from the portable terminal in which the processing is to be ended (step S710).

In step S710, substantially the same processing as step S610 described in the fifth exemplary embodiment is performed. In the present exemplary embodiment, a description will be given, concerning operation when in step S710, it is determined that as to portable terminal 702 and portable terminal 703, the distances from manipulation equipment 700 are smaller than or equal to the threshold, so that the processing can be continued, and as to portable terminal 704, the distance from manipulation equipment 700 is larger than the threshold, so that the processing should be ended.

Manipulation equipment 700 extracts the voiceprint information from the voice uttered by user 701 (step S711).

Manipulation equipment 700 transmits the voiceprint information (the first biometric information) extracted in step S711 to the portable terminals which are determined that the processing can be continued (in the example shown in FIG. 11, portable terminal 702 and portable terminal 703) in step S710, and inquires whether or not the voiceprint information coincides with voiceprint information 613 (the second biometric information) registered beforehand (step S712).

The portable terminals that have received the inquiry in step S712 (in the example shown in FIG. 11, portable terminal 702 and portable terminal 703) collate the voiceprint information (the first biometric information) transmitted from manipulation equipment 700 with voiceprint information 613 (the second biometric information) registered inside the portable terminals beforehand. Collation results are then answered to manipulation equipment 700 (step S713).

Manipulation equipment 700 identifies the portable terminal that has answered coincidence in step S713. Manipulation equipment 700 continues the processing to the portable terminal that has answered the coincidence, and ends the processing to the portable terminal that has answered incoincidence (step S714).

In the present exemplary embodiment, the operation example in which portable terminal 702 has answered the coincidence and portable terminal 703 has answered the incoincidence to manipulation equipment 700 is described. Accordingly, in the example shown in FIG. 11, manipulation equipment 700 continues the processing to portable terminal 702, and ends the processing to portable terminal 703.

Manipulation equipment 700 analyzes the voice command of user 701 input to manipulation equipment 700 in step S706, and converts the voice command to a character string (step S715). While in the present exemplary embodiment, an operation example in which a character string of “open” is obtained by the processing in step S715 will be described, the present disclosure is not limited thereto.

In steps S711, S712, S713, S714, and S715, substantially the same processing as steps S611, S612, S613, S614, and S615 described in the fifth exemplary embodiment is performed.

In the operation example shown in FIG. 11, manipulation equipment 700 determines that it is requested by user 701 to open the door. Here, it is supposed that a personal identification number is required for the opening of the door, and the personal identification number is not registered in manipulation equipment 700. In this case, manipulation equipment 700 operates so as to acquire necessary information (here, the personal identification number to open the door) from portable terminal 702. When acquiring information with high confidentiality such as the personal identification number and the like, it is supposed that manipulation equipment 700 is set beforehand so as to use a secure communication path. Based on this setting, manipulation equipment 700 transmits an establishment request of the communication path (e.g., WebSocket connection or the like) to portable terminal 702 (step S716), and establishes the communication path with portable terminal 702 (step S717).

Manipulation equipment 700 transmits a request to portable terminal 702 through the communication path (e.g., the WebSocket connection) established in step S717 (step S718). While in the example described in the present exemplary embodiment, this request is made for the personal identification number to open the door, the present disclosure is not limited thereto.

Based on the request transmitted from manipulation equipment 700 in step S718, portable terminal 702 searches for information corresponding to the request, and returns the information obtained as a result of the search to manipulation equipment 700 (step S719).

Manipulation equipment 700 uses the information obtained in step S719, and executes the operation based on the analysis result of the voice command obtained in step S715 (the operation based on the voice manipulation of user 701) (step S720). In the example described in the present exemplary embodiment, manipulation equipment 700 executes the operation of opening the door (or operation of unlocking the door) through the use of the personal identification number obtained in step S719.

If there is no shortage of the information when manipulation equipment 700 executes the operation based on the voice command, the processing in steps S716 to S719 is unnecessary.

### [6-3. Effects and the Like]

As described above, in the present exemplary embodiment, the biometric authentication system has a substantially similar configuration to that of biometric authentication system 10 described in the first exemplary embodiment, and can perform the biometric authentication of user 701.

Furthermore, in the present exemplary embodiment, the biometric authentication system includes the plurality of pieces of terminal equipment each configured to be able to measure the current location of the terminal equipment itself. The manipulation equipment is configured to be able to mutually communicate with each of the plurality of pieces of terminal equipment. The manipulation equipment is configured to inquire of each of the plurality of pieces of terminal equipment about the current location of the relevant terminal equipment itself, calculate the respective distance between the manipulation equipment and the relevant terminal equipment, based on the position information answered from the relevant terminal equipment and the position information of the manipulation equipment itself, and decide the terminal equipment to which the first biometric information is to be transmitted, based on the calculated distance.

In the present exemplary embodiment, biometric authentication system 16 is one example of the above-described biometric authentication system, manipulation equipment 700 is one example of the manipulation equipment, portable terminals 702, 703 and 704 are examples of the terminal equipment, and the voiceprint information is one example of the biometric information.

This enables manipulation equipment 700 to limit the portable terminal to which the biometric authentication is to be requested to portable terminals 702 and 703 in the vicinity of manipulation equipment 700. Furthermore, manipulation equipment 700 is enabled to establish the communication path with portable terminal 702, which has succeeded in the biometric authentication, and obtain the necessary information from portable terminal 702.

In this configuration, for example, even if the biometric information of user 701 permitted to pass the door is not registered in manipulation equipment 700, manipulation equipment 700 can perform the biometric authentication using the biometric information of user 701, and execute the operation of opening the door (or the operation of unlocking the door), based on the result of the biometric authentication.

### Other Exemplary Embodiments

As described above, the first to sixth exemplary embodiments have been described as examples of the technique disclosed in the present disclosure. However, the technique in the present disclosure is not limited thereto, but that can also be applied to exemplary embodiments resulting from modifications, replacements, additions, omissions and the like. Moreover, the respective components described in the foregoing first to sixth exemplary embodiments can also be combined to provide new exemplary embodiments.

Consequently, hereinafter, other exemplary embodiments will be exemplified.

In the second exemplary embodiment, the configuration example has been described in which the continuation/end of the processing is determined in manipulation equipment 200, based on the intensity of the signal received by portable terminal 201 from access point 202. However, the present disclosure is not limited to this configuration. For example, the biometric authentication system may be configured such that similar determination is performed, based on quality of the signal received by the portable terminal from the access point. The above-described configuration can also bring about substantially similar effects to the effects described in the second exemplary embodiment.

In the second to fourth exemplary embodiments, the operation example in which manipulation equipment 200 inquires the signal intensity and the SSID, the position information or the like of portable terminal 201 has been described. However, the present disclosure is not limited to this configuration. For example, those inquiries may be sent from the portable terminal. For example, the biometric authentication system may be configured such that the portable terminal functions as an access point, the portable terminal inquires the signal intensity, the SSID and the like to the manipulation equipment, and only when the portable terminal determines that the manipulation equipment is installed in the vicinity of the portable terminal, a collation result between the first biometric information and the second biometric information is transmitted from the portable terminal to the manipulation equipment. The above-described configuration can also bring about substantially similar effects to the effects described in the second to fourth exemplary embodiments.

In the second and third exemplary embodiments, the configuration in which manipulation equipment 200 determines the continuation/end of the processing, based on the signal intensity answered from portable terminal 201 is described. However, the present disclosure is not limited to this configuration. For example, the biometric authentication system may be configured such that by adjusting the output signal intensity of the access point or the like, a range where the signal of the access point can be received is limited beforehand, and that the processing of the biometric authentication is continued with respect to the portable terminal within the range. In the above-described configuration as well, substantially similar effects to the effects described in the second and third exemplary embodiments can be obtained.

In the third exemplary embodiment, the configuration is described in which manipulation equipment 200 generates the SSID, transmits the SSID to access point 202, and requests the setting of the SSID to access point 202. However, the present disclosure is not limited to this configuration. For example, the biometric authentication system may be configured such that the access point generates the SSID by itself, sets the SSID in the access point itself, and notifies the manipulation equipment of the SSID. The above-described configuration can also bring about substantially similar effects to the effects described in the third exemplary embodiment.

In the fifth exemplary embodiment, the configuration has been described in which manipulation equipment 200 possesses its own position information beforehand. However, the present disclosure is not limited to this configuration. For example, the biometric authentication system may be configured such that the manipulation equipment have a function of detecting its own current location, and acquire its own position information before the operation of the biometric authentication starts. The above-described configuration can also bring about substantially similar effects to the effects described in the fifth exemplary embodiment.

In the first to sixth exemplary embodiments, a number of times of request for the biometric authentication from the manipulation equipment to the portable terminal is not particularly mentioned. However, a restriction may be put on this number of times. For example, an upper limit within a unit time (e.g., up to five times for 10 minutes) may be put on the number of times of request for the biometric authentication from the manipulation equipment to the portable terminal, or a number of times of acceptance of the request for the biometric authentication by the portable terminal. Since this prevents the biometric authentication from being performed without limitation in the biometric authentication system, security regarding information leakage can be increased.

Alternatively, the manipulation equipment that can request the biometric authentication may be limited on the portable terminal side, or the portable terminal to which the biometric authentication is to be requested may be limited on the manipulation equipment side. This can increase the security regarding the information leakage as well. This configuration can be implemented, for example, by registering, in the portable terminal, the manipulation equipment that permits the request for the biometric authentication, or by registering a passcode or a certificate in the manipulation equipment to transmit the passcode to the portable terminal at the time of the request for the biometric authentication.

Moreover, in order to prevent the manipulation equipment from communicating with the portable terminal away from the manipulation equipment, as for a structure around the manipulation equipment (e.g., in the case where the manipulation equipment is installed in a vehicle, a body, windows, and the like of the vehicle; in the case where the manipulation equipment is installed indoors, walls, windows and the like of the building), a structure that hardly passes radio waves in a specific frequency band (e.g., a frequency band used in the communication between the manipulation equipment and the portable terminal) may be employed. Since this can narrow a communicable range of the manipulation equipment, the communication between the portable terminal away from the manipulation equipment and the manipulation equipment can be prevented. Moreover, there is a possibility that opening the windows of the vehicle or the building decreases the above-described prevention effect. Accordingly, limitation such as prohibition of the biometric authentication when the windows are opened may be put on the biometric authentication system. Moreover, the manipulation equipment may be configured such that the temporary stop of the biometric authentication is notified to a user together with a reason thereof.

### INDUSTRIAL APPLICABILITY

The present disclosure can be applied to a biometric authentication system that performs authentication of a user by means of biometric information to permit only the authenticated user to operate or manipulate the equipment. Specifically, the present disclosure can be applied to an electronic settlement terminal, a security door, a computer, a call device, a server computer, a network connection device and the like.

### REFERENCE MARKS IN THE DRAWINGS

10, 11, 13, 15, 16: biometric authentication system

21, 621: biometric information input unit

22, 32, 42, 52, 53, 622, 632: controller

23, 33 43, 623, 633: communicator

24, 34, 624, 634, 724: operator

100, 200, 500, 600, 700: manipulation equipment

101, 601, 701 user

102, 201, 501, 602, 603, 604, 702, 703, 704: portable terminal

103: biometric information

110, 610: recorder

202, 605, 705: access point

613: voiceprint information

1. A biometric authentication system comprising manipulation equipment and terminal equipment configured to be able to communicate with each other,
wherein the manipulation equipment is configured such that biometric information of a user can be input thereto as first biometric information,
the terminal equipment is configured such that the biometric information of the user can be registered beforehand as second biometric information, and
the manipulation equipment is configured to transmit the first biometric information input by the user to the terminal equipment and request the terminal equipment to collate the first biometric information with the second biometric information.

2. The biometric authentication system according to claim 1, wherein
the terminal equipment is configured to be able to transmit and receive a radio signal with an access point of radio communication, and
the manipulation equipment is configured to inquire a signal intensity of the access point of the terminal equipment, and determine whether or not to continue processing of a biometric authentication, based on the signal intensity answered from the terminal equipment.

3. The biometric authentication system according to claim 1, wherein
the terminal equipment is configured to be able to transmit and receive a radio signal with an access point of radio communication, and
the manipulation equipment is configured to generate first information to be set in the access point, request setting of the first information to the access point, transmit second information for identifying the access point to the terminal equipment, inquire of the terminal equipment about a signal intensity of the access point and the first information set in the access point, and determine whether or not to continue processing of biometric authentication, based on the signal intensity and the first information answered from the terminal equipment.

4. The biometric authentication system according to claim 1, wherein
the terminal equipment is configured to be able to measure a current location of the terminal equipment itself, and
the manipulation equipment is configured to inquire of the terminal equipment about the current location of the terminal equipment, calculate a distance between the manipulation equipment and the terminal equipment, based on position information answered from the terminal equipment and position information of the manipulation equipment itself, and determine whether or not to continue processing of biometric authentication, based on the calculated distance.

5. The biometric authentication system according to claim 1 comprising a plurality of pieces of the terminal equipment each configured to be able to measure a current location of the terminal equipment itself,
wherein the manipulation equipment is configured to be able to mutually communicate with the plurality of pieces of terminal equipment, and is configured to inquire of each of the plurality of pieces of terminal equipment about the current location of the terminal equipment itself, calculate a distance between the manipulation equipment and each of the plurality of pieces of terminal equipment, based on position information answered from the terminal equipment and position information of the manipulation equipment itself, and decide a terminal equipment to which the first biometric information is to be transmitted, based on the calculated distances.

6. A biometric authentication method in a biometric authentication system comprising manipulation equipment and terminal equipment configured to be able to communicate with each other, the biometric authentication method comprising the steps of;
inputting biometric information of a user to the manipulation equipment as first biometric information;
transmitting the first biometric information from the manipulation equipment to the terminal equipment;
requesting collation between the first biometric information and second biometric information from the manipulation equipment to the terminal equipment, the second biometric information being registered beforehand in the terminal equipment; and
answering a result of the collation from the terminal equipment to the manipulation equipment.

7. Manipulation equipment used in biometric authentication, wherein
the manipulation equipment is configured such that biometric information of a user can be input thereto as first biometric information, and
the manipulation equipment is configured to transmit the first biometric information input by the user to terminal equipment, and request the terminal equipment to collate the first biometric information with biometric information of the user registered beforehand as second biometric information in the terminal equipment.
